(19) United States
(12) Patent Application Publication
(10) Pub. No.: US 2009/0138443 A1
(43) Pub. Date: May 28, 2009

(54) METHOD AND SYSTEM FOR SEARCHING FOR A KNOWLEDGE OWNER IN A NETWORK COMMUNITY

(75) Inventors: I-Kun HUANG, Taipei City (TW); Wen-Tai HSIEH, Taipei City (TW); Jyun-Cheng WANG, Hsinchu City (TW); Jung-Chang HO, Chiayi Hsien (TW)

Correspondence Address: FOLEY AND LARDNER LLP;SUITE 500, 3000 K STREET NW, WASHINGTON, DC, 20007, US

(73) Assignee: INSTITUTE FOR INFORMATION INDUSTRY

(21) Appl. No.: 12/126,893

(22) Filed: May 25, 2008

(30) Foreign Application Priority Data
Nov. 23, 2007 (TW) 096144552

(51) Int. Cl. G06F 17/30

(52) U.S. Cl. 707/3; 707/E17.014

(57) ABSTRACT

A method for searching for a knowledge owner in a network community is executed in conjunction with a network platform database of a network platform, and includes the following steps: (A) extracting at least one keyword from a question submitted by an asker X; (B) using the at least one keyword as a topic, searching the network platform database for network users Y₁˜Yₙ who have participated in discussions on the topic; (C) analyzing discussion histories of the network users Y₁˜Yₙ on the network platform and finding at least one index value for each of the network users Y₁˜Yₙ according to the discussion histories; and (D) according to the index values, selecting at least one knowledge owner associated with the topic from the network users Y₁˜Yₙ and recommending the at least one knowledge owner to the asker X. A system for executing the method is also disclosed.

### CROSS-REFERENCE TO RELATED APPLICATION

This application claims priority of Taiwanese Application No. 096144552, filed on Nov. 23, 2007.

### BACKGROUND OF THE INVENTION

1. Field of the Invention

The invention relates to a method and system for analyzing a network community, more particularly to a method and system for searching for a knowledge owner in a network community.

2. Description of the Related Art

In this era of knowledge explosion, new knowledge is being generated at every corner of the world every minute. Both old and new knowledge are distributed over the Internet to be shared and discussed by people everywhere in the world. As a result, knowledge sharing networks and forums dedicated to various fields of knowledge associated with living, education, technology, recreation, etc., have come into being and flourish. Take the Yahoo! Answers (Traditional Chinese) website as an example. Since the community of users of the website is large, there are approximately 2.8 answers to each question, and approximately 450 entries of knowledge are generated every hour on the average. To date, the entire database of the website stores approximately 9 million entries of knowledge. It is therefore evident that there is a huge amount of knowledge resources that can be shared over the Internet among network users, and that searching for information on the Internet or posting questions/answers have become routine for modern people when looking for answers to questions.

Although questions submitted to a network platform, such as Yahoo! Answers, are largely answered, since the platform evaluates the professional level of a user who answers a question by the rating given by other users on the network platform, the rating is relatively subjective and is prone to deliberate manipulation, and a user with a high rating may not necessarily be an “expert.” In addition, it is not uncommon that a user may answer many questions that he/she actually does not know just to get points. The associated drawback for the asker is, therefore, where to find the real expert. The asker can only sit and wait for an answer, and can do nothing about it even if there is not any satisfactory answer. Even if there is a rough answer to the question, the asker cannot reach the user answering the question to further discuss the question.

To make better use of the knowledge resources among network users on the Internet, there is evidently a need to find a mechanism that can increase chances of successful knowledge exchanges.

### SUMMARY OF THE INVENTION

Therefore, an object of the present invention is to provide a method for searching for a knowledge owner in a network community using a network community analysis approach.

Another object of the present invention is to provide a system for searching for a knowledge owner in a network community using a network community analysis approach.

Accordingly, the system for searching for a knowledge owner in a network community of the present invention is adapted to be connected to a network platform database of a network platform and to cooperate with the network platform database to execute a method for searching for a knowledge owner in a network community in response to a question submitted by an asker X. The system includes a keyword extracting module, a search module connected to the keyword extracting module and the network platform database, a history analyzing module connected to the search module, and a recommendation module connected to the history analyzing module. The method of the present invention includes the following steps:

(A) enabling the keyword extracting module to extract at least one keyword from the question;

(B) using the at least one keyword as a topic, enabling the search module to search the network platform database for network users Y₁˜Yₙ who have participated in discussions on the topic;

(C) enabling the history analyzing module to analyze interactive discussion histories of the network users Y₁˜Yₙ on the network platform and to find at least one index value for each of the network users Y₁˜Yₙ according to the discussion histories; and

(D) according to the index values, enabling the recommendation module to select at least one knowledge owner associated with the topic from the network users Y₁˜Yₙ and to recommend the at least one knowledge owner to the asker X.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram to illustrate a preferred embodiment of a system for searching for a knowledge owner in a network community according to the present invention;

FIG. 2 is a flowchart to illustrate a preferred embodiment of a method for searching for a knowledge owner in a network community according to the present invention;

FIG. 3 is a schematic network diagram to illustrate exemplary network relationships among network users Y₁˜Yₙ who have a discussion relationship with respect to a topic;

FIG. 4 is a flowchart to illustrate steps of calculating distance index values in the preferred embodiment; and

FIG. 5 is a schematic network diagram to illustrate exemplary network relationships formed between an asker X and network users Y₁˜Yₙ through network users Z₁˜Zₖ.

### DETAILED DESCRIPTION OF THE PREFERRED EMBODIMENT

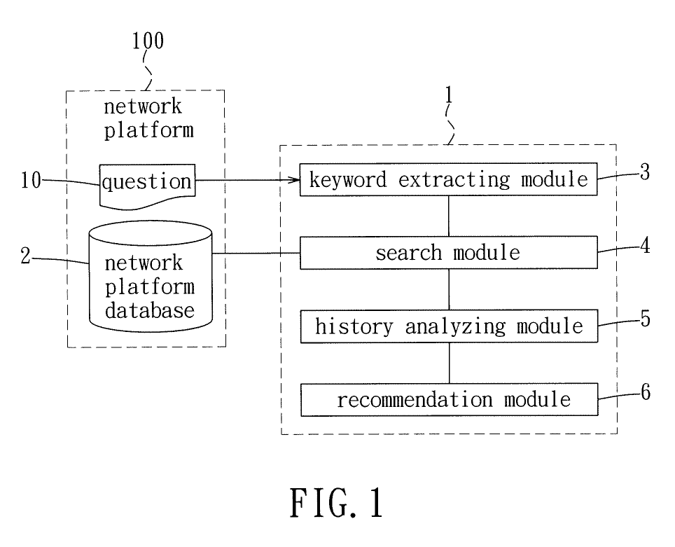

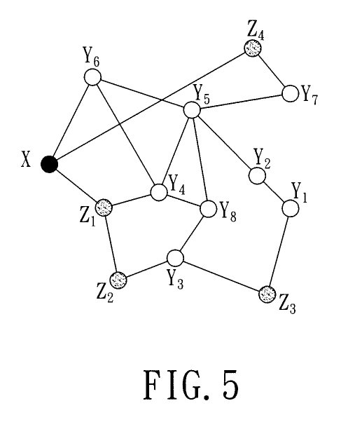

Referring to FIG. 1, the preferred embodiment of a system 1 for searching for a knowledge owner in a network community is adapted to be connected to a network platform database 2 of a network platform 100 that supports the network community and searches for a knowledge owner from a plurality of users of the network platform 100 in response to a question 10 submitted by an asker X (see FIG. 5). The network platform 100 refers to a discussion forum or message board of a website, or a website dedicated to knowledge exchange, such as Yahoo! Answers. The network community is a community of users of the network platform 100 (hereinafter referred to as network users).

The system 1 for searching for a knowledge owner in a network community of the present invention includes a keyword extracting module 3, a search module 4 connected to the keyword extracting module 3 and the network platform database 2 of the network platform 100, a history analyzing module 5 connected to the search module 3, and a recommendation module 6 connected to the history analyzing module 5.

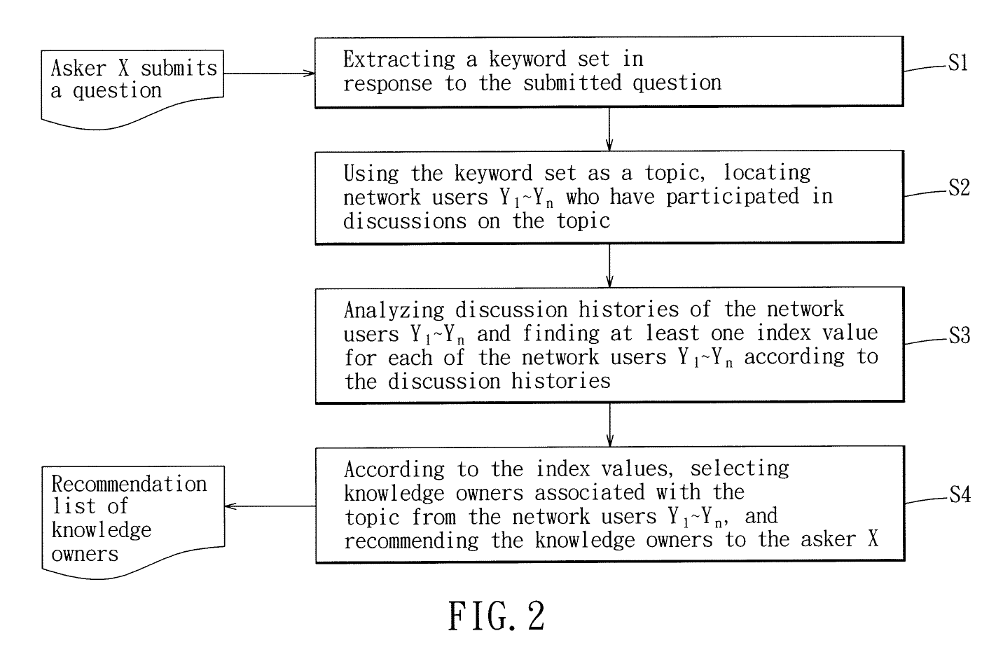

Referring to FIGS. 1 and 2, when the asker X submits a question 10, e.g., “how to write a socket program in Java?”, to the network platform 100, the system 1 will start executing the method for searching for a knowledge owner in a network community of the present invention by carrying out the following steps:

In step S1, in response to the submitted question 10, the keyword extracting module 3 extracts at least one keyword from the question 10. In the above example, three keywords, “Java,” “socket” and “program,” are extracted. The keyword extracting module 3 further forms a keyword set by expanding the at least one keyword based on the concept or related words of the at least one keyword.

The keyword set in step S1 may be formed by establishing links with words that frequently appear with the extracted keyword in the network platform database 2 of the network platform 100, which is equivalent to constructing a word relevancy network.

In the example, “J2EE” and “J2SE” which frequently appear with the keyword “Java” are located, “TCP” and “port” which frequently appear with the keyword “socket” are located, and “API” and “tool” which frequently appear with the keyword “program” are located. Thus, with respect to the question 10 submitted by the asker X, the keyword set formed by the keyword extracting module 3 includes the following keywords: Java, J2EE, J2SE, socket, TCP, port, program, API, and tool.

In step S2, the search module 4 uses the aforesaid keyword set as a topic and searches the network platform database 2 of the network platform 100 for network users Y₁˜Yₙ who have participated in discussions on the topic.

In step S3, the history analyzing module 5 analyzes discussion histories of the network users Y₁˜Yₙ on the network platform 100, and finds at least one index value for each of the network users Y₁˜Yₙ according to the discussion histories. The index values are to be used in the preparation of a recommendation list of knowledge owners by the recommendation module 6. In this embodiment, four index values are found for each of the network users Y₁˜Yₙ. Below is a description of the four index values and the method of finding the index values. However, it is noted that the present invention should not be limited to the disclosure herein. Fewer than four or more than four index values may be found in other embodiments of the invention.

I. Centrality

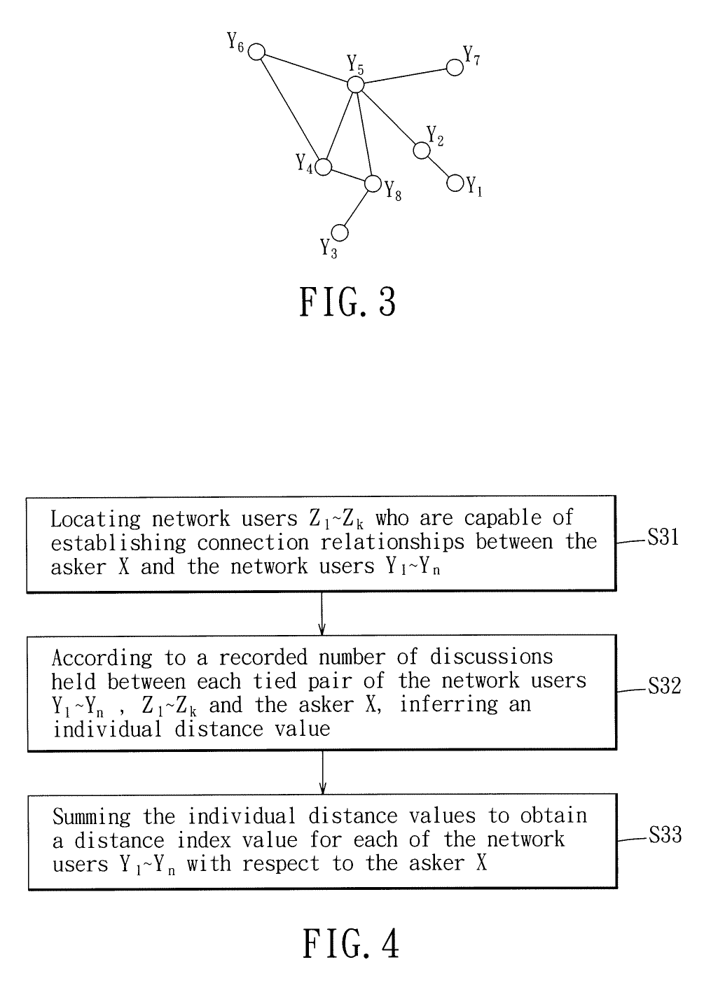

In finding centrality index values, for any two of the network users Y₁˜Yₙ that have had a discussion therebetween on the topic, a tie or edge is formed therebetween to thereby establish network relationships among the network users Y₁˜Yₙ such as those shown in FIG. 3. Subsequently, a total number of ties for each of the network users Y₁˜Yₙ is tallied. For example, in FIG. 3, the total number of ties for the network user Y₁ is 1, and the total number of ties for the network user Y₅ is 5. A centrality index value for each of the network users Y₁˜Yₙ is found based on the respective total number of ties. In this embodiment, the centrality index value of each of the network users Y₁˜Yₙ is equal to a ratio of the total number of ties of the network user to the highest possible number of ties thereof (e.g., in FIG. 3, where n=8, the highest possible number of ties of each network user is n−1, i.e., 7).

Generally, if a network user has a relatively high centrality index value, this indicates that he/she has had a relatively large number of discussions with other network users on the topic. The case may be, the network user has obtained answers from many of the other network users or has answered the questions posted by many of the other network users with respect to the topic. Therefore, based on the centrality index value of each network user, an inference as to whether the respective network user played a relatively important role in the discussions on the topic in the network community can be made.

II. Efficiency

In this embodiment, the efficiency index value is found using an algorithm formulated by Ronald S. Burt. The theoretical basis for Burt's algorithm is to compute structural holes in social resources. A network user who occupies a structural hole is generally considered to have ready access to useful information, often plays the role of a broker, and has more opportunities to obtain non-redundant resources or even control interests.

A formula used to compute the efficiency of each network user in the network community based on Burt's algorithm is as follows:

$$Efficiency = {\sum }_{j} [ 1 - {\sum }_{q} {p}_{iq} {m}_{jq} ] , q \neq i , j$$

where i represents a network actor (object for calculation), j represents other network actors, and q represents network actors other than i and j. The formula is used to compute a number of contacts between the network actor i and each of the network actors j, and the numbers of contacts are summed. When computing the contact relationship between the network actor i and one of the network actors j, values of P_{iq} and m_{jq} are calculated for each of the network actors q, where P_{iq} is the degree of involvement of the network actor in the contact relationship with the network actor q, and m_{jq} represents the marginal strength brought about by the connection with the network actors j and q. If the efficiency value is equal to 1, this indicates that the corresponding network actor is probably located in a structural hole.

In the example shown in FIG. 3, in the network constituted by the network users Y₁˜Yₙ who have participated in the discussions on the topic, those with a higher efficiency value are more likely to be able to obtain many resources. Therefore, this index value is taken into consideration in the preparation of the recommendation list of knowledge owners.

III. Distance

Referring to FIGS. 1, 2 and 4, finding of the distance index value includes the following steps:

In step S31, the network platform database 2 of the network platform 100 is searched to locate any network users Z₁˜Zₖ that can establish connection relationships between the asker X and the network users Y₁˜Yₙ, and a tie or edge is formed between any two of the network users Y₁˜Yₙ, Z₁˜Zₖ and the asker X which have had a discussion relationship so as to establish network relationships among the network users Y₁˜Yₙ, Z₁˜Zₖ and the asker X. As shown in FIG. 5, the asker X establishes a connection relationship with the network user Y₄ through the network user Z₁, establishes a connection relationship with the network user Y₃ through the network users Z₁ and Z₂, and so on and so forth. Moreover, a number of discussions held between each tied pair of the network users Y₁-Yₙ, Z₁˜Zₖ and the asker X is recorded.

In step S32, the recorded number of discussions obtained in step S31 is used to infer an individual distance value for each tied pair of the network users Y₁˜Yₙ, Z₁˜Zₖ and the asker X. In this embodiment, the individual distance value is equal to a reciprocal of the recorded number of discussions. For instance, supposing the asker X had three discussions with the network user Z₁, and the network user Z₁ had two discussions with the network user Y₄, the distance value of the asker X with respect to the network user Z₁ is ⅓, i.e., approximately 0.33, and the distance value of the network user Z₁ with respect to the network user Y₄ is ½, i.e., approximately 0.5.

In step S33, at least one of the individual distance values for a path from the asker X to one of the network users Y₁˜Yₙ is summed so as to obtain a distance index value for said one of the network users Y₁˜Yₙ with respect to the asker X. For instance, the distance index value of the network user Y₄ with respect to the asker X is the sum of 0.33 and 0.5, i.e., 0.83.

The distance index value thus found in this embodiment represents the closeness between the asker X and the network users Y₁˜Yₙ, Z₁˜Zₖ. The lower the distance index value, the closer will be the discussion relationship between the asker X and the corresponding network user. Generally, it can be inferred that the network users with comparatively low distance index values with respect to the asker X probably have the answer to the question 10 submitted by the asker X. Therefore, distance index values should be considered when preparing the recommendation list of knowledge owners in connection with the topic.

IV. Structural Equivalence

In this embodiment, structural equivalence is calculated using a CONCOR (convergence of iterated correlations) algorithm. The CONCOR algorithm is a procedure of iterating correlations, in which pairwise dissimilarities in the pattern of ties of all the nodes in a network are calculated, generally using the Euclidean distance, so as to obtain a matrix. Using the matrix, a CONCOR analysis is applied to locate the nodes (network user Y₁˜Yₙ) that are structurally equivalent to the asker X. A tree diagram or dendrogram is used to represent the extent of structural equivalence among the nodes. The higher the value of structural equivalence, the more similar will be the structural position of the corresponding node to the asker X in the network community. Therefore, structural equivalence can be used as a parameter for searching for knowledge owners associated with the topic. In the aforementioned calculation of the Euclidean distance, it is supposed that there are five nodes, A, B, C, D and E. To find the dissimilarity in ties between nodes A and B, the number of ties from B to C is subtracted from the number of ties from A to C and the difference is squared. The ties of the nodes D and E are computed in the same way. All the values are summed, and a square root of the sum is taken to obtain a value indicating the dissimilarity in ties between A and B.

In step S4, according to the various index values for each of the network users Y₁˜Yₙ, the recommendation module 6 selects at least one knowledge owner associated with the topic from the network users Y₁˜Yₙ, and recommends the at least one knowledge owner to the asker X. For instance, the system 1 may provide the following recommendation list to the asker X:
Regarding the topic of how to write a socket program in Java, the network users who have frequent interactions are Y5, Y4 and Y8.
The network users who may obtain many resources are Y1, Y2, Y3, and Y7.
The network user who is likely to respond to your question is Y4.
The network user who is structurally equivalent to you on the topic in the discussion community is Y6.

It is noted that the finding of the index values of centrality and efficiency belongs to a computation of absolute relationships in the network community, and the analyses are mainly directed to the network users who have participated in the discussions on the topic in the network platform 100. The inclusion of the distance index value and the structural equivalence index value is to bring the asker X into the context of the network community, so that the discussion history of the asker X on the network platform 100 or the position or importance of the asker X in the network community can also affect the results of the index values. With the inclusion of the various index values, a multi-dimensional and relatively objective comprehensive recommendation list can be obtained. According to the recommendation list and depending on actual situations, the asker X can evaluate whether or not to make an active connection with specific network users. Hence, the asker X can directly ask the knowledge owner(s) for an answer, and no longer needs to wait for a response.

In addition, the form of the recommendation list is certainly not limited to that disclosed in the embodiment. The recommendation module 6 can use characteristic ones of the index values (i.e., those index values that are more substantial and significant) as the basis for selecting knowledge owners, and can even use a combination-type formula to make a comprehensive calculation of the index values so as to obtain a single candidate or a ranking list of candidates for the knowledge owner(s).

In sum, in the method and system for searching for a knowledge owner in a network community according to the present invention, the discussion histories of the network users on the network platform 100 who have participated in discussions on a topic related to the question 10 submitted by the asker X are analyzed for calculating various index values of significance to serve as a basis for recommending knowledge owners. This invention fully exploits the abundant interaction data within a network community, and is of considerable help to the asker X by increasing chances of a successful exchange of knowledge.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for searching for a knowledge owner in a network community, which is adapted to be executed in conjunction with a network platform database of a network platform in response to a question submitted by an asker X, said method comprising the following steps:
(A) extracting at least one keyword from the question;
(B) using the at least one keyword as a topic, searching the network platform database of the network platform for network users Y₁˜Yₙ who have participated in discussions on the topic;
(C) analyzing discussion histories of the network users Y₁˜Yₙ on the network platform and finding at least one index value for each of the network users Y₁˜Yₙ according to the discussion histories; and
(D) according to the index values, selecting at least one knowledge owner associated with the topic from the network users Y₁˜Yₙ and recommending the at least one knowledge owner to the asker X.

2. The method for searching for a knowledge owner in a network community according to claim 1, wherein the at least one keyword extracted in step (A) is expanded to form a keyword set based on concept or related words thereof, and the network platform database of the network platform is searched in step (B) using the keyword set as the topic.

3. The method for searching for a knowledge owner in a network community according to claim 1, wherein, in step (C), the network users Y₁˜Yₙ who have participated in discussions on the topic are interconnected to establish network relationships among the network users Y₁˜Yₙ, and the at least one index value is found on the basis of the network relationships.

4. The method for searching for a knowledge owner in a network community according to claim 3, wherein, a total number of ties for each of the network users Y₁˜Yₙ to other network users Y₁˜Yₙ is tallied, and a centrality value is found from the total number of ties, the at least one index value including the centrality value.

5. The method for searching for a knowledge owner in a network community according to claim 4, wherein the centrality value of each of the network users Y₁˜Yₙ is equal to a ratio of the total number of ties of the respective network user to a highest possible number of ties of the respective network user.

6. The method for searching for a knowledge owner in a network community according to claim 1, wherein, in step (C), a Burt's algorithm is used to find an efficiency value of each of the network users Y₁˜Yₙ, the at least one index value including the efficiency value.

7. The method for searching for a knowledge owner in a network community according to claim 1, wherein, in step (C), network users Z₁˜Zₖ capable of establishing connection relationships between the asker X and the network users Y₁˜Yₙ are located, and a tie is formed between any two of the network users Y₁˜Yₙ and Z₁˜Zₖ and the asker X which have had a discussion relationship so as to establish network relationships among the network users Y₁˜Yₙ and Z₁˜Zₖ and the asker X.

8. The method for searching for a knowledge owner in a network community according to claim 7, wherein, in step (C), a number of discussions held between each tied pair of the network users Y₁˜Yₙ and Z₁˜Zₖ and the asker X is recorded for inferring an individual distance value for each tied pair of the network users Y₁˜Yₙ and Z₁˜Zₖ and the asker X, and at least one of the individual distance values for a path from the asker X to one of the network users Y₁˜Yₙ is summed so as to obtain a distance index value for said one of the network users Y₁˜Yₙ, the at least one index value including the distance index value.

9. The method for searching for a knowledge owner in a network community according to claim 8, wherein the individual distance value is equal to a reciprocal of the recorded number of discussions.

10. The method for searching for a knowledge owner in a network community according to claim 1, wherein, in step (C), a structural equivalence value is found for each of the network users Y₁˜Yₙ using a CONCOR algorithm, the at least one index value including the structural equivalence value.

11. A system for searching for a knowledge owner in a network community, said system being adapted to be connected to a network platform database of a network platform and comprising:
a keyword extracting module for extracting at least one keyword from a question submitted by an asker X;
a search module connected to said keyword extracting module and the network platform database of the network platform for searching the network platform database using the at least one keyword as a topic for network users Y₁˜Yₙ who have participated in discussions on the topic;
a history analyzing module connected to said search module for analyzing discussion histories of the network users Y₁˜Yₙ on the network platform and for finding at least one index value for each of the network users Y₁˜Yₙ according to the discussion histories; and
a recommendation module for selecting at least one knowledge owner associated with the topic from the network users Y₁˜Yₙ according to the index values and for recommending the least one knowledge owner to the asker X.

12. The system for searching for a knowledge owner in a network community according to claim 11, wherein said keyword extracting module expands the at least one keyword extracted thereby to form a keyword set based on concept or related words thereof, and said search module uses the keyword set as the topic for searching for the network users Y₁˜Yₙ.

13. The system for searching for a knowledge owner in a network community according to claim 11, wherein said history analyzing module interconnects the network users Y₁˜Yₙ who have participated in discussions on the topic to establish network relationships among the network users Y₁˜Yₙ, and the at least one index value is found on the basis of the network relationships.

14. The system for searching for a knowledge owner in a network community according to claim 13, wherein said history analyzing module tallies a total number of ties for each of the network users Y₁˜Yₙ to other network users Y₁˜Yₙ, and finds a centrality value from the total number of ties, the at least one index value including the centrality value.

15. The system for searching for a knowledge owner in a network community according to claim 14, wherein the centrality value of each of the network users Y₁˜Yₙ is equal to a ratio of the total number of ties of the respective network user to a highest possible number of ties of the respective network user.

16. The system for searching for a knowledge owner in a network community according to claim 11, wherein said history analyzing module uses a Burt's algorithm to find an efficiency value of each of the network users Y₁˜Yₙ, the at least one index value including the efficiency value.

17. The system for searching for a knowledge owner in a network community according to claim 11, wherein said history analyzing module locates network users Z₁˜Zₖ capable of establishing connection relationships between the asker X and the network users Y₁˜Yₙ, and forms a tie between any two of the network users Y₁˜Yₙ and Z₁˜Zₖ and the asker X which have had a discussion relationship so as to establish network relationships among the network users Y₁˜Yₙ and Z₁˜Zₖ and the asker X.

18. The system for searching for a knowledge owner in a network community according to claim 17, wherein said history analyzing module records a number of discussions held between each tied pair of the network users Y₁˜Yₙ and Z₁˜Zₖ and the asker X for inferring an individual distance value for each tied pair of the network users Y₁˜Yₙ and Z₁˜Zₖ and the asker X, and sums the individual distance values for a path from the asker X to one of the network users Y₁˜Yₙ so as to obtain a distance index value for said one of the network users Y₁˜Yₙ, the at least one index value including the distance index value.

19. The system for searching for a knowledge owner in a network community according to claim 18, wherein the individual distance value is equal to a reciprocal of the recorded number of discussions.

20. The system for searching for a knowledge owner in a network community according to claim 11, wherein said history analyzing module finds a structural equivalence value for each of the network users Y₁˜Yₙ using a CONCOR algorithm, the at least one index value including the structural equivalence value.
